(19) United States
(12) Patent Application Publication
(10) Pub. No.: US 2018/0352411 A1
(43) Pub. Date: Dec. 6, 2018

(54) METHOD AND DEVICE FOR DIRECT COMMUNICATION BETWEEN TERMINALS

(71) Applicant: Samsung Electronics Co., Ltd., Suwon-si, Gyeonggi-do (KR)

(72) Inventors: Hyun-Seok RYU, Yongin-si (KR); Peng XUE, Suwon-si (KR); Seung-Hoon PARK, Seoul (KR); Sang-Won CHOI, Seoul (KR)

(21) Appl. No.: 15/562,286

(22) PCT Filed: Apr. 8, 2016
(86) PCT No.: PCT/KR2016/003714

§ 371 Date: Sep. 27, 2017

Related U.S. Application Data
(60) Provisional application No. 62/145,695, filed on Apr. 10, 2015.

(51) Int. Cl. H04W 8/00; H04W 72/08; H04B 7/155

(52) U.S. Cl. CPC H04W 8/005; H04W 88/02; H04B 7/155; H04W 72/085

(57) ABSTRACT

The present disclosure relates to a 5G or pre-5G communication system for supporting a higher data transmission rate, following 4G communication systems such as LTE. According to the present disclosure, a direct communication method between terminals (D2D) comprises the steps of: the terminal receiving synchronization information and system information for D2D communication from at least one counterpart terminal; the terminal measuring the signal strength for a link with the at least one counterpart terminal; and the terminal determining on the basis of the measured signal strength, at least one counterpart terminal as a relay terminal connecting the network with the terminal, and transmitting data to the determined relay terminal.

### PRIORITY

This application is a National Phase Entry of PCT International Application No. PCT/KR2016/003714, which was filed on Apr. 8, 2016, and claims a priority to U.S. Provisional Patent Application No. 62/145,695, which was filed on Apr. 10, 2015, the contents of which are incorporated herein by reference.

### TECHNICAL FIELD

The present disclosure relates to a method and apparatus for discovering and detecting a relay in a communication system supporting device-to-device (D2D) communication.

### BACKGROUND ART

To satisfy the increasing demands for wireless data traffic since commercialization of 4the generation (4G) communication systems, efforts have been made to develop an improved 5^{th} generation (5G) communication system or a pre-5G communication system. For this reason, the 5G or pre-5G communication system is referred to as a beyond-4G or post long term evolution (LTE) system.

To achieve high data rates, deployment of the 5G communication system in a millimeter wave (mmWave) band (for example, a 60-GHz band) is under consideration. For the 5G system, beamforming, massive multiple input multiple output (MIMO), full dimensional MIMO (FD-MIMO), array antenna, analog beamforming, and large-scale antenna techniques have been discussed in order to mitigate the path loss and propagation distance of waves.

Further, for network improvement in a system, technologies such as advanced small cell, cloud radio access network (RAN), ultra-dense network, device-to-device (D2D) communication, wireless backhaul, moving network, cooperative communication, coordinated multi-point (COMP), and interference cancellation have been developed in the 5G system.

Besides, advanced coding modulation (ACM) techniques such as hybrid FSK and QAM modulation (FOAM) and sliding window superposition coding (SWSC), and advanced access techniques such as filter bank multi carrier (FBMC), non-orthogonal multiple access (NOMA), and sparse code multiple access (SCMA) have been developed in the 5G system.

Meanwhile, owing to the recent emergence of Internet of things (IoT), D2D communication has attracted much interest as one of communication techniques for interaction with smart devices. D2D communication is conducted based on physical proximity between user equipments (UEs), and offers many benefits including increased efficiency of network resources, reduction of the power consumption of UEs, and extended cellular communication coverage. In this context, the 3rd generation partnership project (3GPP) selected D2D communication as a study item in Release 12, started to study its validity under the name of proximity-based service (PreSe) in 2011, and has worked on full-scale standardization of D2D communication since 2013.

Long term evolution (LTE)-based D2D communication technology may be divided into D2D discovery and D2D communication. D2D discovery is a process of detecting the identities or interests of other UEs in the vicinity by one UE, or announcing the identity or interest of the UE to other UEs in the vicinity by the UE. The identity and interest of a UE may be an identifier (ID) of the UE, an application ID, or a service ID, and may be configured in various manners according to a D2D service and an operation scenario.

If the layers of a UE are a D2D application layer, a D2D management layer, and a D2D transport layer, the D2D application layer refers to D2D service application programs executed on an operating system (OS) of the UE, the D2D management layer is responsible for converting discovery information generated in a D2D application program to a format suitable for the transport layer, and the transport layer refers to a physical/media access control (PHY/MAC) layer in LTE or wireless fidelity (WiFi) wireless communication standards. D2D discovery may be performed in the following procedure. Once a user executes a D2D application program, the D2D application layer generates discovery information and provides the discovery information to the D2D management layer. The D2D management layer converts the discovery information received from the D2D application layer to a management layer message. This management layer message is transmitted through the transport layer of the UE. Upon receipt of the management layer message, UEs perform a reception operation in a reverse order of the transmission procedure.

Meanwhile, D2D communication is a communication technique of directly transmitting traffic between UEs without intervention of an infrastructure such as an evolved Node B (eNB) or an access point (AP). After D2D discovery is performed, D2D communication may be conducted (with a discovered UE) based on the result of the D2D discovery, or D2D communication may be conducted without D2D discovery. Whether D2D discovery is required before D2D communication may depend on a D2D service and an operation scenario.

D2D service scenarios may be divided largely into commercial service or non-public safety service, and public safety service. Each service may include a huge number of use cases, for example, advertisement, social network service (SNS), game, and public safety service.

Meanwhile, in Rel-12 LTE D2D, both D2D discovery and D2D communication are performed in LTE uplink (UL) subframes. That is, a D2D transmitter transmits a D2D discovery signal and data for D2D communication in UL subframes, and a D2D receiver receives the UL subframes. Since a UE receives data and control information from an eNB on a downlink (DL) and transmits data and control information to the eNB on a UL in a legacy LTE system, the D2D transmitter/receiver may operate in a different manner from in the legacy LTE system. For example, a UE that does not support D2D functionality is provided with an orthogonal frequency division multiple access (OFDMA)-based receiver to receive DL data and control information from an eNB, for cellular communication, and needs a single carrier-frequency division multiple access (SC-FDMA)-based transmitter to transmit UL data and control information to the eNB. However, a D2D UE should support both a cellular mode and a D2D mode, and thus should be equipped with an additional SC-FMDA-based receiver for receiving D2D data and control information on a UL as well as an OFDMA-based receiver for receiving DL data from an eNB and an SC-FDMA-based transmitter for transmitting UL data or control information to the eNB or transmitting D2D data and control information.

To extend the coverage of an out of network-coverage UE (OOC UE) located outside the coverage of an eNB in the 3GPP LTE Rel-13 enhanced D2D (eD2D) standards, a study was started on a UE-to-network (UE2NW) relay. Data transmitted by an eNB may be transmitted to an OOC UE through a D2D UE serving as a UE2NW relay, and data transmitted by an OOC UE may be transmitted to the eNB (or network) through an in-coverage UE (IC UE) within the coverage of the eNB.

FIG. 1 is a simplified view illustrating a general D2D communication system including an IC UE, an OCC UE, and a UE2NW relay.

Meanwhile, a D2D UE activing as a UE2NW relay (hereinafter, referred to as a relay UE) characteristically supports a layer 3 (L3) relay function. That is, layer 1 (L1) and layer 2 (L2) of the relay UE do not know whether received data is destined for the relay UE (that is, whether the relay UE is a final destination) or the relay UE is supposed to forward the data to an eNB or an OOC UE. Since this determination is made in L3, L1 and L2 are transparent from the perspective of reception at the UE. Further, L1 and L2 are also transparent from the perspective of transmission from the UE. That is, L3 3 determines whether transmission data has been generated in the relay UE or should be forwarded to the eNB or the OOC UE, whereas L1 and L2 do not make the determination.

### DISCLOSURE

### Technical Problem

In Rel-12 D2D, an OOC UE may receive a D2D synchronization signal transmitted by IC UEs. The D2D synchronization signal transmitted by the IC UEs is cell-specific. That is, when the OOC UE receives synchronization signals from a plurality of IC UEs in the same cell, the OOC UE may not determine what UEs have transmitted the synchronization signals or how many UEs have transmitted the synchronization signals. Further, Rel-12 D2D defines only relay of a D2D synchronization signal without defining operations and procedures of an eNB and a UE for relaying D2D data. Although institute of electrical and electronics engineers (IEEE) 802.16j, IEEE 802.16m, and IEEE 802.16n standards made studies to support relay between UEs, these standards are not about LTE D2D-based relay and thus may be different from operations of an eNB and a UE for supporting the Rel-13 eD2D UE2NW relay functionality.

Accordingly, the present disclosure is intended to provide a method and apparatus for operating an eNB and a D2D UE, for relaying D2D data.

### Technical Solution

According to an embodiment of the present disclosure, a device-to-device (D2D) communication method includes receiving synchronization information for D2D communication and system information from at least one second user equipment (UE) by a first UE, measuring a signal strength of a link with the at least one second UE by the first UE, determining that the at least one second UE is a relay UE connecting the network to the first UE based on the measured signal strength by the first UE, and transmitting data to the determined relay UE by the first UE.

According to another embodiment of the present disclosure, a UE for D2D communication includes a transceiver for conducting cellular communication with a network and conducting D2D communication with at least one correspondent UE in a direct communication path, and a controller for controlling reception of synchronization information for D2D communication and system information from the at least one correspondent UE, measurement of a signal strength of a link with the at least one correspondent UE, determination that the at least one second UE is a relay UE connecting the network to the UE based on the measured signal strength, and transmission of data to the determined relay UE.

According to another embodiment of the present disclosure, a D2D communication method includes transmitting synchronization information for D2D communication and system information to a second UE by a first UE, receiving data from the second UE by the first UE, determining, if the received data includes identification information about the first UE, that the first UE is a relay UE connecting the network to the second UE, and transmitting the data to the network.

According to another embodiment of the present disclosure, a UE for D2D communication includes a transceiver for conducting cellular communication with a network and conducting D2D communication with a correspondent UE in a direct communication path, and a controller for controlling transmission of synchronization information for D2D communication and system information to the correspondent UE, reception of data from the correspondent UE, determination, if the received data includes identification information about the UE, that the UE is a relay UE connecting the network to the correspondent UE, and transmission of the data to the network.

According to another embodiment of the present disclosure, a D2D communication method includes transmitting synchronization information for D2D communication and system information to a second UE by a first UE, receiving data from the second UE by the first UE, measuring a signal strength of a link between the first UE and the second UE or a signal strength of a link between the first UE and a network by the first UE, reporting the measured signal strength to the network by the first UE, receiving a data transmission command from the network by the first UE, and transmitting the data received from the second UE to the network by the first UE.

According to another embodiment of the present disclosure, a UE for D2D communication includes a transceiver for conducting cellular communication with a network and conducting D2D communication with a correspondent UE in a direct communication path, and a controller for controlling transmission of synchronization information for D2D communication and system information to the correspondent UE, reception of data from the correspondent UE, measurement of a signal strength of a link between the UE and the correspondent UE or a signal strength of a link between the UE and a network, reporting of the measured signal strength to the network, reception of a data transmission command from the network, and transmission of the data received from the correspondent UE to the network.

### BRIEF DESCRIPTION OF THE DRAWINGS

FIG. 1 is a simplified view illustrating a general device-to-device (D2D) communication system.

FIG. 2 is a view illustrating a method for selecting a user equipment-to-network (UE2NW) relay by an out of network-coverage (OOC) UE according to a first embodiment of the present disclosure.

FIG. 3 is a view illustrating a method for directly determining a relay operation by a UE2NW relay according to a second embodiment of the present disclosure.

FIG. 4 is a view illustrating a method for selecting a UE2NW relay by a network according to the first embodiment of the present disclosure.

FIG. 5 is a block diagram of a UE according to an embodiment of the present disclosure.

FIG. 6 is a block diagram of an evolved Node B (eNB) according to an embodiment of the present disclosure.

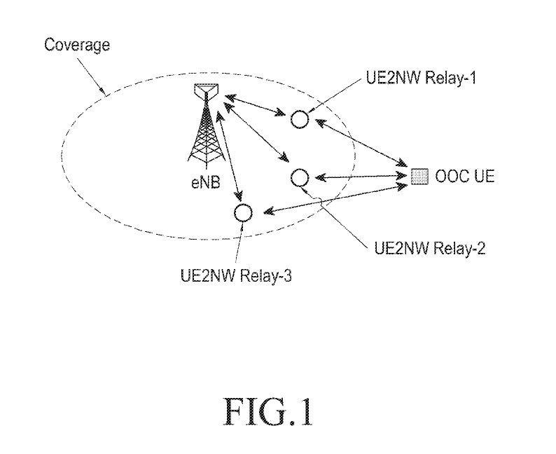

### MODE FOR CARRYING OUT THE INVENTION

Embodiments of the present disclosure will be described in detail with reference to the attached drawings. A detailed description of a generally known function or structure of the present disclosure will be avoided lest it should obscure the subject matter of the present disclosure. Although terms as described below are defined in consideration of functions in the present disclosure, the terms may be changed according to the intention of a user or an operator, or customs. Therefore, the present disclosure should be understood, not simply by the actual terms used but by the meanings of each term lying within.

Before a detailed description of the present disclosure, interpretable meanings of a few terms as used in the present disclosure will be presented. However, it is to be noted that the terms are not limited to the following interpretation example.

A base station (BS) is an entity communicating with a user equipment (UE). The BS may also be referred to as Node B (NB), evolved Node B (eNB or eNode B), an access point (AP), and so on. A UE is an entity communicating with a BS. The UE may also be referred to as a mobile station (MS), a mobile equipment (ME), a device, a terminal, and so on.

Now, a description will be given of a method and apparatus for operating an eNB and a device-to-device (D2D) UE to relay D2D data according to an embodiment of the present disclosure, with reference to the attached drawings.

Methods for determining for a D2D UE to perform a relay operation will first be described.

First, an eNB may directly command UEs having the capability of supporting UE-to-network (UE2NW) relay functionality to perform a relay operation, among D2D UEs in radio resource control (RRC)_Connected state. Which D2D UEs are capable of supporting the UE2NW relay functionality may be determined through UE capabilities negotiation, when D2D UEs initially access the network (eNB). Further, a determination as to which UE will perform a relay operation may be an implementation issue of the eNB. For example, when D2D UEs having the capability of supporting the UE2NW relay functionality are in the RRC_Connected state, the eNB may measure the channel qualities of uplinks (ULs) between the eNB and D2D UEs using UL signals (for example, a physical uplink shared channel (PUSCH), a physical uplink control channel (PUCCH), a sounding reference signal (SRS), or a physical random access channel (PRACH)), and determine a UE which will perform the relay operation based on the measured channel qualities.

Secondly, D2D UEs having the capability of supporting the UE2NW relay functionality may perform a relay operation by autonomous determination. This operation may apply to all of UEs in cellular RRC_Idle state and cellular RRC_Connected state. For example, the eNB broadcasts a predetermined threshold to all UEs having the capability of supporting the UE2NW relay functionality within the cell by a system information block (SIB). Upon receipt of the threshold, UEs may measure received downlink (DL) signals. If the measurements are less than the threshold broadcast by the eNB (that is, if the UEs are apart from the eNB by a predetermined distance or larger), the UEs may start a relay operation. Herein, the received DL signals may be measured in terms of reference signal received powers (RSRPs). Hereinbelow, an RSRP measured on a DL will be referred to as a DL-RSRP.

Thirdly, the above-described two methods may be combined. For example, the eNB may transmit a measurement threshold along with a command allowing D2D UEs in the RRC_Connected state to perform a UE2NW relay operation, and the D2D UEs receiving the measurement threshold may perform DL-RSRP measurement, compare the measurements with the threshold received from the eNB, and only when the measurements are less than the threshold, perform the UE2NW relay operation.

A command indicating whether the UE2NW relay functionality is to be performed or discontinued may be transmitted by dedicated RRC signaling, and on/off of the relay functionality may be indicated by a 1-bit indication that the eNB transmits to a UE. For example, upon receipt of UE2NE_relay=on by dedicated RRC signaling, a D2D UE performs the relay functionality. In addition, upon receipt of UE2NE_relay=off, a D2D UE discontinues the relay functionality.

D2D UEs which have received a command to perform the UE2NW relay functionality from the network (or eNB) perform the relay functionality. The relay functionality includes transmission of a D2D synchronization signal (side-link synchronization signal (SLSS)), and broadcasting of a channel (physical sidelink broadcast channel (PSBCH)) including D2D system information. The SLSS includes information about an SLSS ID, and an SLSS ID included in an SLSS transmitted by a relay may be indicated cell-specifically in an SIB by the network (or eNB) or UE-specifically by dedicated RRC signaling by the network (or eNB). If the SLSS ID is indicated in an SIB, all UE2NW relays within the cell use the same SLSS ID. If the SLSS ID is indicated UE-specifically by dedicated RRC signaling, the UE2NW relays within the cell may use different SLSS IDs.

Meanwhile, a UE2NW relay transmitting an SLSS and a PSBCH performs UE2NW relay announcement to announce the existence of the UE2NW relay to OCC UEs. The announcement may be transmitted by an SLSS ID or by indication information indicating relay announcement on the PSBCH. In addition, relay announcement information may be included in a discovery message transmitted on a physical sidelink discovery channel (PSDCH), or in a D2D communication message transmitted on a physical sidelink shared channel (PSSCH).

If the UE2NW announcement is transmitted by an SLSS ID, an OCC UE may be aware of the existence of the UE2NW relay during SLSS ID detection. In Rel-12 D2D, an SLSS may be transmitted in a center 6-resource block (RB) frequency of a D2D synchronization channel. To support transmission of a UE2NW relay announcement in Rel-13 eD2D, a Rel-12 SLSS and a Rel-13 SLSS may be transmitted in the same subframe by frequency division.

If the UE2NW announcement is transmitted on the PSBCH, an OOC UE may be aware of the existence of the UE2NW relay during decoding of the received PSBCH. In Rel-12 D2D, the PSBCH may be transmitted in a center 6-RB frequency of a D2D synchronization channel. To support transmission of a UE2NW relay announcement in Rel-13 eD2D, a Rel-12 PSBCH and a Rel-13 PSBCH may be transmitted in the same subframe by frequency division.

If the UE2NW relay announcement is transmitted in a discovery message on a PSDCH, an OOC UE may be aware of the existence of the UE2NW relay during decoding of the PSDCH.

If the UE2NW relay announcement is transmitted in a communication message on a PSSCH, an OOC UE may be aware of the existence of the UE2NW relay during decoding of the PSSCH. For this purpose, the following additional operation is required. In Rel-12, to transmit a PSSCH, a D2D UE should transmit a physical sidelink control channel (PSCCH). The PSCCH includes control information required to decode the PSSCH (for example, a modulation order and channel coding rate of the PSSCH, the positions of PSSCH resources on the time and frequency axes, timing advance information for helping a receiver to set a fast Fourier transform (FFT) window for decoding the PSSCH, a destination ID helping the receiver to determine whether to decode the PSSCH, and so on). Particularly, the destination ID included in the PSCCH is a parameter indicating a destination to receive the PSSCH. If the ID does not identify the D2D UE that has decoded the PSCCH, the D2D UE does not decode the PSSCH. Therefore, if the UE2NW relay announcement is transmitted on the PSSCH, a destination ID included in the PSCCH is needed. Since the UE2NW relay does not know the existence of an OOC UE, the destination ID included in the PSCCH may be set to a specific value (for example, 0 or 1) in this case. If the destination ID included in the PSCCH is set to the specific value, the OOC UE may determine that the UE2NW relay has transmitted the PSCCH.

Now, a description will be given of methods for selecting a UE2NW relay according to an embodiment of the present disclosure.

If a plurality of UE2NW relays are located within the D2D communication coverage of a D2D UE, a specific UE2NW relay may be selected to thereby prevent unnecessary resource consumption. The present disclosure proposes three embodiments that differ in entities responsible for selecting a UE2NW relay.

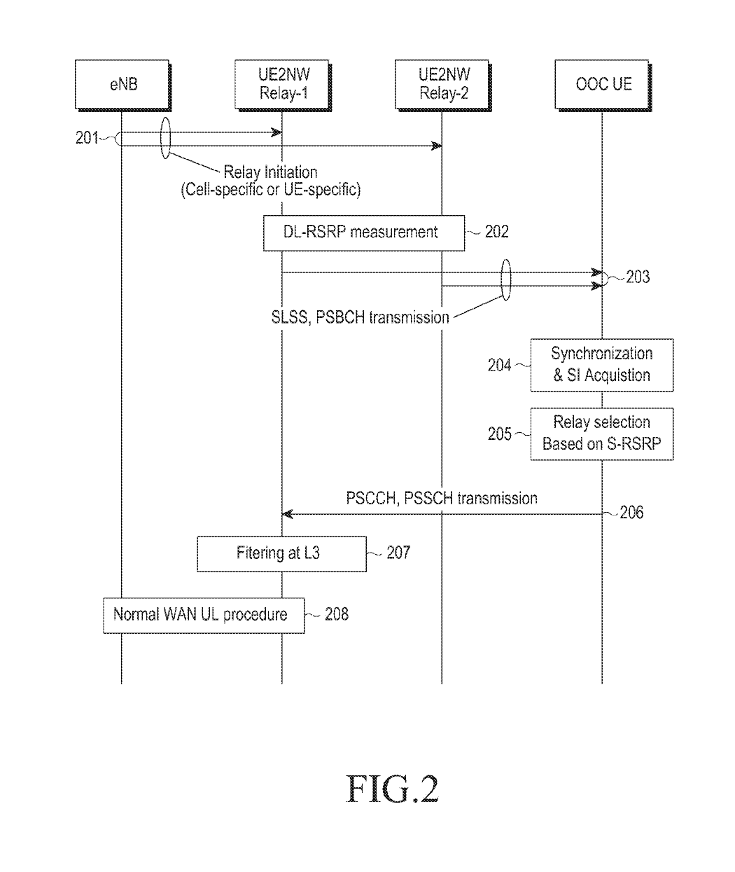

FIG. 2 illustrates a case in which an OOC UE selects a UE2NW relay according to a first embodiment of the present disclosure.

Referring to FIG. 2, an eNB directly commands a relay operation to D2D UEs having the capability of supporting the UE2NW relay functionality within a cell (201). This command may be transmitted to one or more UE2NW relays in RRC_Connected state by UE-specific dedicated RRC signaling. In this case, the eNB may indicate a threshold for DL-RSRP measurement and an SLSS ID that the UE2NW relays will transmit. Further, the eNB may cell-specifically indicate the threshold for DL-RSP measurement to all UEs having the UE2NW relay functionality existing within its cell by an SIB. In this case, the SLSS ID that the UE2NW relay will transmit may also be included in SIB information.

Upon receipt of the command indicating operation as a UE2NW relay, UE2NW relays measure DL-RSRPs, compared the DL-RSRP measurements with the DL-RSRP threshold received by the dedicated RRC signaling or the SIB, and determine whether to operate as a UE2NW relay based on the comparison (202). That is, if the measured DL-RSRP values are larger than the threshold, the UE2NW relays determine to behave as a UE2NW relay and transmit SLSSs and relay discovery announcement messages on a PSBCH or a PSDCH (203). Upon receipt of the SLSSs and the PSBCH or PSDCH from the UE2NW relays, an OOC UE performs time and frequency synchronization using the SLSS and acquires system information (SI) from the PSBCH (204). Further, the OOC UE may acquire identification information about the UE2NW relays by decoding the PDSCH. The SI may include an S-RSRP threshold needed for the OOC UE to select a relay. The OOC UE may select a relay based on S-RSRP measurements, and the S-RSRP measurements may be obtained from demodulation reference signals (DMRSs) transmitted on the PSBCH. The OOC UE may select one relay having the largest S-RSRP value or two or more relays having S-RSRPs equal to or larger than the threshold from among a plurality of UE2NW relays (205). The OOC UE may compare the S-RSRP threshold with its measured S-RSRP values and selects a relay based on the comparison (205). The S-RSRP threshold may be included in SI, as described before, or may be preconfigured. To select a relay using an S-RSRP, the OOC UE needs to distinguish relays. The OCC UE may identify relays by SLSS IDs used by the different relays, relay information included in the PSBCH, discovery messages transmitted on PSDCHs, or D2D communication messages transmitted on PSSCHs. In FIG. 2, since the S-RSRP of UE2NW Relay-1 is larger than the S-RSRP of UE2NW Relay-2, the OOC UE selects UE2NW Relay-1.

Further, when the OOC UE selects a UE2NW relay, the OOC UE may reflect a link quality between the UE2NW relay and the eNB in addition to the S-RSRP condition. For example, the UE2NW relay may transmit a DL-RSRP measurement between the UE2NW relay and the eNB on a PSBCH, a PSCCH, a PSDCH, or a PSSCH. Upon receipt of the DL-RSRP value, the OOC UE may select the relay using an S-RSRP measured by the OOC UE and the DL-RSRP measured by the UE2NW relay. Various selection criteria may be available. For example, the OOC UE may select a single relay having a maximum value of min{S-RSRP, DL-RSRP}. Or the OOC UE may select two or more relays having min{S-RSRP, DL-RSRP} value equal to or larger than a threshold. The threshold may be transmitted to the OOC UE on the PSBCH, as described before.

Meanwhile, the OOC UE which has selected UE2NW Relay-1 transmits a PSCCH and a PSSCH to the selected UE2NW Relay-1 (206). Herein, the ID of UE2NW Relay-1 is included in the PSCCH. After receiving data from the OOC UE, UE2NW Relay-1 determines whether the data is supposed to be transmitted to the eNB through L3 of UE2NW Relay-1 (207). If the data is supposed to be transmitted to the eNB through L3, UE2NW Relay-1 transmits the data to the eNB in a general cellular UL data transmission procedure (208).

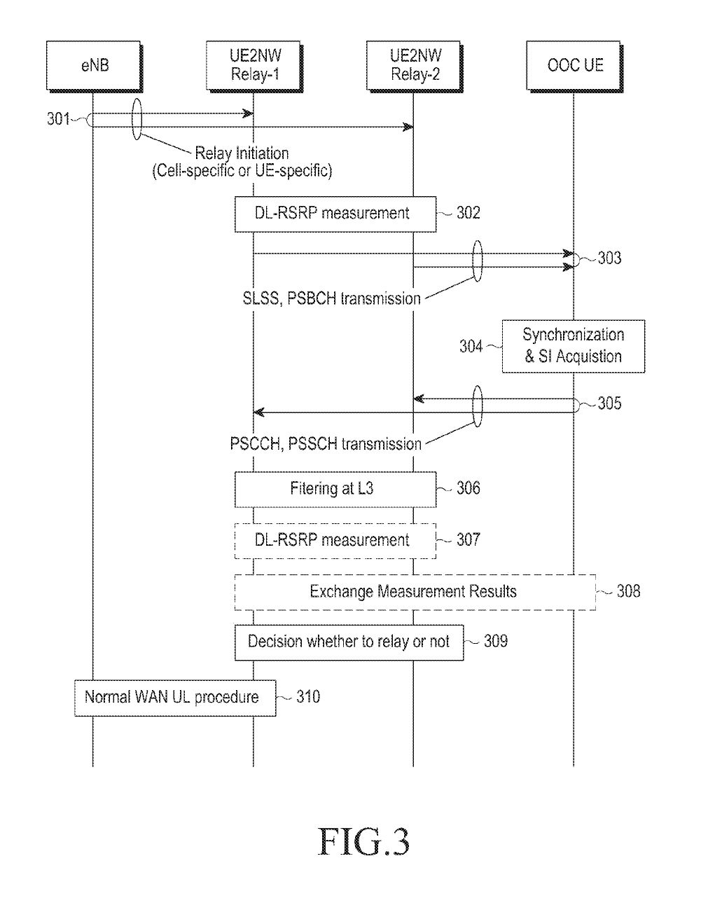

FIG. 3 illustrates a case in which an OOC UE selects a UE2NW relay according to a second embodiment of the present disclosure.

Referring to FIG. 3, operations 301 to 304 are identical to operations 201 to 204 of FIG. 2. That is, upon receipt of UE2NW relay announcement messages from one or more UE2NW relays (303), the OOC UE performs time and frequency synchronization through an SLSS and acquires SI on a PSBCH (304), thereby recognizing the existence of the UE2NW relays around the OOC UE. The OOC UE transmits data destined for an eNB (or network) to the recognized UE2NW relays (305). Herein, a PSCCH and a PSSCH are transmitted. Destination IDs included in the PSCCH may be SLSS IDs that the UE2NW relays have transmitted, and the ID of the OOC UE may be included in the PSSCH. Upon receipt of the PSCCH from the OOC UE, if the PSCCH includes the SLSS IDs that the UE2NW relays have transmitted, the UE2NW relays may determine that the PSSCH transmitted in time-frequency resources indicated by the PSCCH is data to be transmitted to the eNB through L3(306). If a plurality of UE2NW relays receive the PSCCH and the PSSCH from the OOC UE, each UE2NW relay measures a link quality (PSSCH-RSRP) between the OOC UE and the UE2NW relay (307). If the measured PSSCH-RSRP is larger than a threshold, the UE2NW relay determines to operate as a relay (309) and transmits data received from the OOC UE to the eNB (310). Herein, the eNB may transmit the threshold to all UE2NW relays within the cell by an SIB, or to specific relays by dedicated RRC signaling.

Meanwhile, in the process of determining whether a UE2NW relay is to operate as a relay, the UE2NW relay may measure a link quality (DL-RSRP) between the UE2NW relay and the eNB instead of measuring a PSSCH-RSRP. For example, if min{PSSCH-RSRP, DL-RSRP} is equal to or larger than a predetermined threshold, the UE2NW relay may transmit data of the OOC UE. Or if min{S-RSRP, DL-RSRP} is equal to or larger than a predetermined threshold, the UE2NW relay may transmit data of the OOC UE. The eNB may transmit the threshold to all UE2NW relays within the cell by an SIB or to specific relays by dedicated RRC signaling.

In another embodiment, the UE2NW relays may exchange S-RSRP values measured by the UE2NW relays with the OOC UE by direct communication (308). Herein, the S-RSRP values measured by the UE2NW relays may be transmitted along with the IDs of the UE2NW relays in payload of PSSCHs or PSDCHs transmitted by the UE2NW relays.

In the illustrated case of FIG. 3, since an S-RSRP value measured by UE2NW Relay-1 is larger than an S-RSRP transmitted by UE2NW Relay-2, UE2NW Relay-1 determines to transmit data of the OOC UE. If L3 of UE2NW Relay-1 determines that the data is to be transmitted to the eNB, UE2NW Relay-1 transmits the data to the eNB in a general cellular UL data transmission procedure (310).

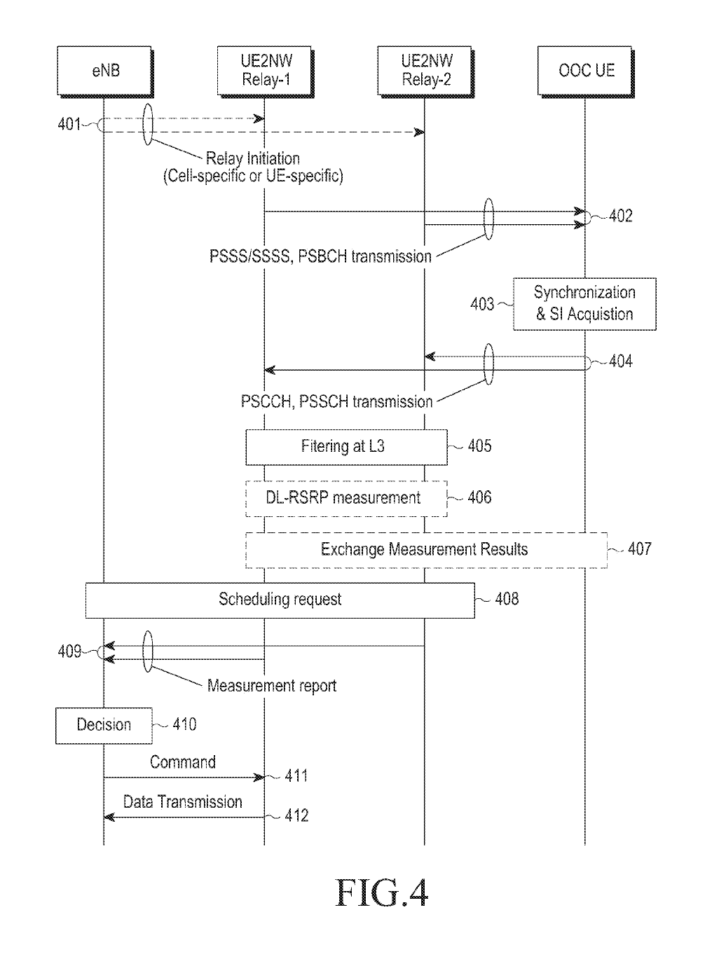

FIG. 4 illustrates a case in which an eNB or network selects a UE2NW relay according to a third embodiment of the present disclosure.

Referring to FIG. 4, operations 401 to 407 are identical to operation 301 and operations 303 to 308 of FIG. 3. FIG. 4 is different from FIG. 3 in that in FIG. 4, UE2NW relays transmit relay announcements by SLSSs and PSBCHs without performing a DL-RSRP measurement operation at the time of receiving a relay operation execution command from an eNB (402). After each UE2NW relay transmits and receives an S-RSRP measured by the UE2NW relay to and from the OCC UE by D2D communication (407), the UE2NW relay reports its measurement result to the eNB (409). The report may include one or both of an S-RSRP (PSSCH-RSRP) being the link quality between the OOC UE and the UE2NW relay and a DL-RSRP being the link quality between the eNB and the UE2NW relay. This report may be transmitted on a UL PUSCH. That is, in the presence of cellular data that the UE2NW relay is to transmit on a UL, report information of an S-RSRP/DL-RSRP may be transmitted piggybacked to cellular data. In the absence of cellular data that the UE2NW relay is to transmit on the UL, the UE2NW relay may be allocated to resources for PUSCH transmission through a scheduling request (408). Herein, if a plurality of UE2NW relays transmit scheduling requests to the eNB, resources may be wasted. Therefore, only when an S-RSRP and a DL-RSRP are equal to or larger than a predetermined threshold, a UE2NW relay may request resources. For example, if an S-RSRP <Threshold1 or a DL-RSRP <Threshold2, the UE2NW relay may request resources. Or if min{S-RSRP, DL-RSRP} <Threshold 3, the UE2NW relay may request resources. Upon receipt of measurement reports from two or more UE2NW relays the eNB may select one or more UE2NW relays in consideration of the received PSSCH-RSRP values and the UL qualities of the UE2NW relays (410). In the illustrated case of FIG. 4, UE2NW Relay-1 is selected. Further, the eNB commands the determined UE2NW relay to transmit data (411). Upon receipt of the data transmission command, the UE2NW relay transmits data to the eNB (412).

According to the UE2NW relay selection methods described above with reference to FIGS. 2, 3 and 4, an entity responsible for selecting a UE2NW relay may be an OCC UE, a UE2NW relay, or an eNB (or network), and measurement information used to select a UE2NW relay may be about a link between an OCC UE and a UE2NW relay or a link between a UE2NW relay and an eNB (or network) depending on the selection entity.

Further, the drawings and embodiments described above may be used individually or two or more of them may be used in combination.

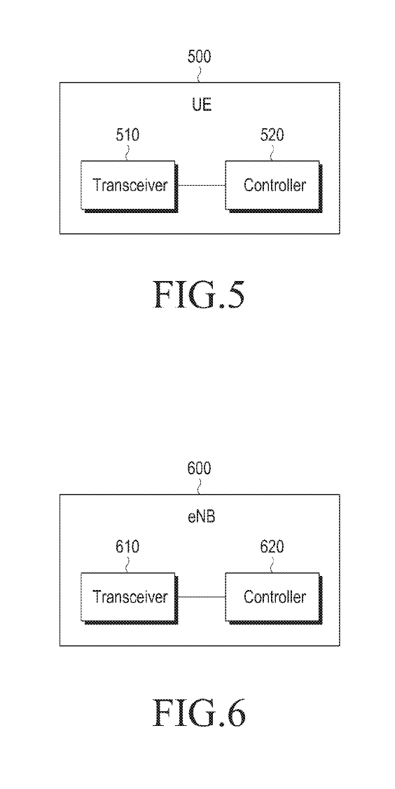

FIG. 5 is a block diagram of an exemplary configuration of a UE according to an embodiment of the present disclosure. The UE of FIG. 5 may be an OCC UE or a UE2NW relay.

A UE 500 may include a transceiver 510 for conducting data transmission with various network nodes and an eNB, and a controller 520 for controlling the transceiver 510. All operations of an OCC UE or a UE2NW relay, as described before may be interpreted as performed under the control of the controller 520.

While the transceiver 510 and the controller 520 are shown as separate components in FIG. 5, the transceiver 510 and the controller 520 may be configured as a single component.

FIG. 6 is a block diagram of an exemplary configuration of a network (eNB) according to an embodiment of the present disclosure.

An eNB 600 may include a transceiver 610 for conducting data transmission with various network nodes and a UE2NW relay, and a controller 620 for controlling the transceiver 610. All operations of an eNB as described before may be interpreted as performed under the control of the controller 620.

While the transceiver 610 and the controller 620 are shown as separate components in FIG. 6, the transceiver 610 and the controller 620 may be configured as a single component.

The afore-described operations may be implemented by providing a memory device storing corresponding program code in a component unit of an entity, a function, an eNB, a P-GW, or a UE in a communication system. That is, a controller of an entity, a function, an eNB, a PDN gateway (P-GW), or a UE may perform the afore-described operations by reading and executing program code stored in a memory device by a processor or a central processing unit (CPU).

Various components, modules, and so on of an entity, a function, an eNB, a P-GW, or a UE may be implemented by use of hardware circuits such as complementary metal oxide semiconductor (CMOS)-based logic circuits, firmware, software, and/or hardware and a combination of hardware, firmware, and/or software embedded in a machine-readable medium. For example, various electrical structures and methods may be implemented by use of electrical circuits such as transistors, logic gates, and an application specific integrated circuit (ASIC).

While the disclosure has been shown and described with reference to certain exemplary embodiments thereof, it will be understood by those skilled in the art that various changes in form and details may be made therein without departing from the spirit and scope of the disclosure as defined by the appended claims and their equivalents.

1. A method of a device-to-device (D2D) communication, the method comprising:
receiving, by a user equipment, a signal and system information from a network;
transmitting, by the user equipment, a relay discovery announcement message to a correspondent user equipment based on the system information;
receiving, by the user equipment, data from the correspondent user equipment and
transmitting, by the user equipment, the received data to the network.

2. The method according to claim 1, wherein the received data includes identification information about the user equipment.

3. The method according to claim 1, wherein the transmitting, by the user equipment, of the received data to the network comprises:
obtaining a signal strength of a link between the user equipment and the correspondent user equipment or a link between the user equipment and the network; and
transmitting, by the user equipment, the received data to the network based on both the signal strength and predetermined threshold.

4. The method according to claim 1, wherein transmitting, by the user equipment, the received data to the network comprises:
obtaining a first signal strength of a link between the user equipment and the correspondent user equipment or a link between the user equipment and the network by the user equipment;
receiving, from one other user equipment, a second signal strength of a link between the one other user equipment and the correspondent user equipment or link between the one other user equipment and the network by the user equipment; and
transmitting, by the user equipment, the received data to the network based on both the first signal strength and the second signal strength.

5-15. (canceled)

16. The method according to claim 1, wherein the transmitting, by the user equipment, of the relay discovery announcement message comprises:
obtaining a signal strength of a link between the user equipment and the network; and
transmitting, by the user equipment, the relay discovery announcement message based on both the signal strength and a predetermined threshold.

17. The method according to claim 16, wherein the predetermined threshold is included in the system information.

18. The method according to claim 1, wherein the signal includes a relay operation execution command.

19. The method according to claim 1, wherein the relay discovery announcement message includes identification information about the user equipment.

20. A method of a device-to-device (D2D) communication, method comprising:
receiving, by a user equipment, a relay discovery announcement message from a correspondent user equipment;
identifying whether the correspondent user equipment is a relay user equipment connecting a network to the user equipment; and
transmitting, by the user equipment, data to the correspondent user equipment.

21. The method according to claim 20, wherein whether the correspondent user equipment is the relay user equipment connecting the network to the user equipment is identified based on at least one of a third signal strength of a link between the user equipment and the correspondent user equipment, and a fourth signal strength of a link between the correspondent user equipment and the network.

22. A user equipment for device-to-device (D2D) communication, the user equipment comprising:
a transceiver configured to perform communication with a network and perform communication with a correspondent UE; and
a controller configured to:
receive a dedicated signal and system information from the network,
transmit a relay discovery announcement message to the correspondent user equipment based on the system information, and
receive data from the correspondent user equipment and transmit the received data to the network.

23. The user equipment according to claim 22, wherein the controller is further configured to:
obtain a signal strength of a link between the user equipment and the network, and
transmit the relay discovery announcement message based on both the signal strength and a predetermined threshold.

24. The user equipment according to claim 22, wherein the received data includes identification information about the user equipment.

25. The user equipment according to claim 22, wherein the controller is further configured to:
obtain a signal strength of a link between the user equipment and the correspondent user equipment or a link between the user equipment and the network, and
transmit the received data to the network based on both the signal strength and a predetermined threshold.

26. The user equipment according to claim 22, wherein the controller is further configured to:
obtain a first signal strength of a link between the user equipment and the correspondent user equipment or a link between the user equipment and the network,
receive, from one other user equipment, a second signal strength of a link between the one other user equipment and the correspondent user equipment or a link between the one other user equipment and the network, and
transmit the received data to the network based on both the first signal strength and the second signal strength.

27. The user equipment according to claim 23, wherein the predetermined threshold is included in the system information.

28. The user equipment according to claim 22, wherein the dedicated signal includes a relay operation execution command.

29. The user equipment according to claim 22, wherein the relay discovery announcement message includes identification information about the user equipment.

30. A user equipment for device-to-device (D2D) communication, the user equipment comprising:
a transceiver configured to perform communication with a correspondent user equipment; and
a controller configured to:
receive a relay discovery announcement message from the correspondent user equipment,
identify whether the correspondent user equipment is a relay user equipment connecting a network to the user equipment, and
transmit data to the correspondent user equipment.

31. The user equipment according to claim 30, wherein the controller is further configured to:
determine the correspondent user equipment as the relay user equipment based on at least one of a third signal strength of a link between the user equipment and the correspondent user equipment, and a fourth signal strength of a link between the correspondent user equipment and the network.
